(19) United States
(12) Patent Application Publication
(10) Pub. No.: US 2013/0144540 A1
(43) Pub. Date: Jun. 6, 2013

(54) CONSTRAINED DE NOVO SEQUENCING OF PEPTIDES

(71) Applicants: Marshall W. Bern, San Carlos, CA (US); Swapnil P. Bhatia, Boston, MA (US)

(72) Inventors: Marshall W. Bern, San Carlos, CA (US); Swapnil P. Bhatia, Boston, MA (US)

(73) Assignee: PALO ALTO RESEARCH CENTER INCORPORATED, Palo Alto, CA (US)

(21) Appl. No.: 13/312,839

(22) Filed: Dec. 6, 2011

(51) Int. Cl. G06F 19/00

(52) U.S. Cl. 702/20

(57) ABSTRACT

A peptide sequencing system derives a peptide sequence from a mass spectrum. The system can receive a description for a peptide sequence constraint, such that the constraint indicates a symbol pattern that is to be present in a peptide sequence derived from the mass spectrum. Then, the system generates a peptide sequence based on the mass spectrum and the constraint, such that the peptide sequence matches the constraint and has a mass that matches the total mass of the peptide as determined from the mass spectrum.

### BACKGROUND

1. Field

This disclosure is generally related to peptide sequencing. More specifically, this disclosure is related to deriving a peptide sequence from a mass spectrum based on a peptide-sequence constraint.

2. Related Art

Peptides (partial proteins) are polymers of amino acids, which can be formed from 20 basic amino acids. Specifically, a peptide is a chain of amino acids linked by peptide bonds to form a specific sequence. The amino acid sequence for a peptide causes the peptide to form a specific molecular shape that interacts with an organism in a specific way. Peptide sequencing is a common procedure in biotechnology and drug discovery, and is often performed to understand how a peptide or protein interacts with the human body. For example, neurotoxic peptides can be isolated from a venomous species (e.g., conotoxins from the venom of cone snails) and analyzed to determine their amino acid sequence. In many instances, understanding the genome for a neurotoxic peptide leads to the development of new pharmaceutical drugs that reliably produce a desired effect on the human body's systems.

Peptide sequencing can be performed by first using a tandem mass spectrometer (MS/MS) to break down charged peptides into a variety of charged and neutral fragments. The mass spectrometer measures the mass-over-charge ratio (m/z) of these fragments and outputs a mass spectrum, which includes a histogram of ion counts (intensities) over a mass-over-charge (m/z) range from zero to the total mass of the peptide. Then, a peptide sequence is determined such that the fragmentation of its amino acids best explains the mass spectrum.

There are two basic approaches often used to determine a peptide sequence for a mass spectrum: database search, and de novo sequencing. Peptide sequencing by a database search derives a peptide sequence by finding the closest match in a protein database that best explains the mass spectrum. For example, a database search can be used to determine a peptide sequence from a low quality mass spectrum that corresponds to a less complete peptide fragmentation, such as in shotgun proteomics. Unfortunately, sequencing a peptide using a database search is not useful for applications where an organism has not been sequenced or has been poorly sequenced.

De novo sequencing derives a peptide sequence from the mass spectrum alone, and can be used to sequence a protein when a protein database is difficult to obtain. Unfortunately, de novo sequencing is a difficult process to perform and can produce an undesirably large number of candidate sequences.

### SUMMARY

One embodiment provides a system that derives a peptide sequence from a mass spectrum. The system can receive a description for a peptide sequence constraint and a mass spectrum, such that the constraint indicates a symbol pattern that is to be present in a peptide sequence derived from the mass spectrum. Then, the system generates a peptide sequence based on the mass spectrum and the constraint, such that the peptide sequence matches the constraint and has a mass that matches the total mass of the peptide as determined from the mass spectrum.

In some embodiments, the constraint comprises a multiset constraint indicating a repetition count for at least one symbol of the peptide sequence. In some other embodiments, the constraint comprises a regular expression constraint indicating at least one sequence position for a symbol of the peptide sequence.

In some embodiments, the system generates the peptide sequence by deriving a plurality of peptide sequences from the mass spectrum, and selecting, from the plurality of peptide sequences, at least one peptide sequence that matches the constraint.

In some embodiments, the system generates a directed graph based on the mass spectrum and the constraint. The directed graph originates at a root vertex that corresponds to a zero mass, and a non-root vertex of the directed graph indicates a mass corresponding to a prefix for a peptide sequence. Further, a path from the root vertex to any interior vertex corresponds to a peptide sequence that does not violate the constraint and whose mass does not exceed the total mass of the peptide as determined from the mass spectrum.

In some embodiments, the system generates the peptide sequence by selecting a set of paths from the directed graph that originate at the root vertex that end at a leaf vertex corresponding to a valid peptide sequence. A valid peptide sequence matches the constraint and has a mass that matches the total mass of the peptide as determined from the mass spectrum. The system then generates a peptide sequence based on a path selected from the directed graph.

In some embodiments, while generating the directed graph, the system annotates a vertex of the directed graph with information pertaining to a peak in the mass spectrum that corresponds to the vertex.

In some embodiments, while generating the directed graph, the system assigns a cost to an edge that couples a first vertex to a second vertex of the directed graph. The system can determine the cost based on a presence of a supporting peak in the mass spectrum, wherein the peak corresponds to the mass of the second vertex. The cost can also be determined based on an intensity of the supporting peak. Further, the cost can be determined based on an amount by which a mass difference between peaks for the first and second vertices resembles an amino acid mass.

In some embodiments, the system selects the set of paths from the directed graph, by determining a number, k, of candidate peptide sequences that are to be generated, and selecting at most k paths that have lowest cost. A path's cost is equal to the aggregate cost for the path's edges. Further, the system can sort or prioritize the selected paths based on their cost.

### BRIEF DESCRIPTION OF THE FIGURES

FIG. 1 illustrates an exemplary peptide sequencing system in accordance with an embodiment.

FIG. 2 presents a flow chart illustrating a process for deriving a collection of candidate peptide sequences from a mass spectrum in accordance with an embodiment.

FIG. 3 presents a flow chart illustrating a process for using a constraint to select a collection of candidate peptide sequences in accordance with an embodiment.

FIG. 4 presents a flow chart illustrating a process for using a constraint to generate a collection of peptide sequences in accordance with an embodiment.

FIG. 5 presents a flow chart illustrating a process for generating a directed graph for generating a peptide sequence in accordance with an embodiment.

FIG. 6A illustrates an exemplary directed multigraph generated using a multiset constraint in accordance with an embodiment.

FIG. 6B illustrates an exemplary directed multigraph generated using a regular expression constraint in accordance with an embodiment.

FIG. 6C illustrates an exemplary mass spectrum for a C. textile toxin in accordance with an embodiment.

FIG. 7 illustrates an exemplary apparatus that facilitates deriving a peptide sequence from a mass spectrum in accordance with an embodiment.

FIG. 8 illustrates an exemplary computer system that facilitates deriving a peptide sequence from a mass spectrum in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of deriving a peptide sequence from mass spectrometry data by providing a peptide sequencing system that uses constraints as guidance. Specifically, the system can use a constraint that indicates partial knowledge of a desired peptide sequence to guide de novo peptide sequencing. The constraint, for example, can include a multiset constraint or a regular expression constraint. The multiset constraint can indicate a repetition count for at least one symbol of the peptide sequence. Further, a regular expression constraint can indicate at least one sequence position for an amino acid symbol of the peptide sequence.

In some embodiments, the peptide sequencing system uses the constraints at an early stage of the peptide sequencing process (e.g., the candidate generation stage) rather than later stages (e.g., scoring, protein assembly, and error correction). These constraints can indicate weak partial knowledge for a peptide sequence, for example, as a number of cysteines (denoted by the amino acid symbol C) in a desired sequence rather than a close homology to a known peptide sequence. Thus, the system can derive a collection of candidate peptide sequences based on the constraints, and can compute a score for each candidate peptide sequence based on a scoring function h that takes the candidate sequence and the mass spectrum as input.

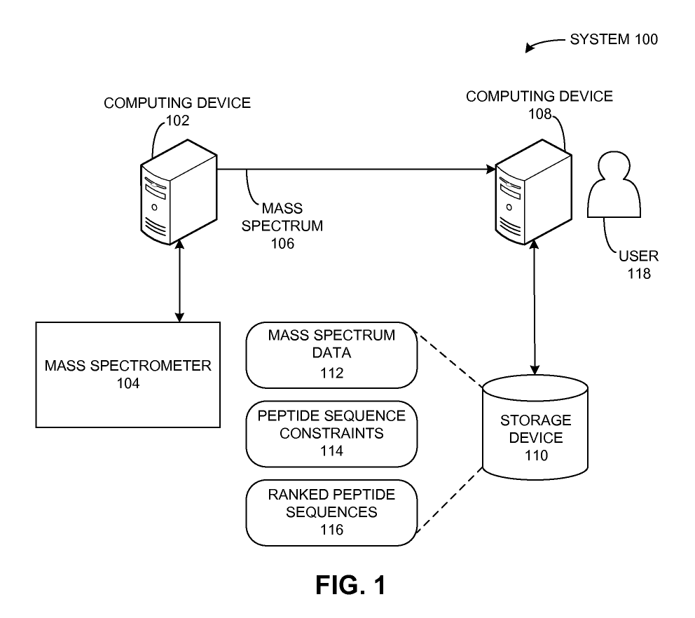

FIG. 1 illustrates an exemplary peptide sequencing system 100 in accordance with an embodiment. System 100 can include a computing device 102 that controls a tandem mass spectrometer 104, and can generate a mass spectrum 106 for an organism such as a protein or a peptide.

Further, system 100 can include a computing device 108 for sequencing the organism. Computing device 108 can receive a mass spectrum 106 from device 102, and can store mass spectrum data 112 data in storage device 110 to include mass spectrum 106. Further, a user 118 can provide computing device 108 with peptide sequence constraints 114 (e.g., via a user interface, a storage medium, or a computer network), and computing device 108 can derive a collection of ranked peptide sequences 116 that satisfy constraints 114 and best explain mass spectrum data 112.

A mass spectrum, indicated by the symbol [symbol] , is defined as a triple (S, M, c). Here, S is a set of pairs of positive real numbers {(m₁, s₁), . . . , (mₐ, sₙ)}, M is a positive real number, and c is an integer. Each pair (mᵢ, sᵢ) in S denotes a peak in the spectrum with a mass-to-charge ration of mᵢ and an intensity sᵢ. M is the sum of the masses of the amino acid residues in its sequence, and is measured using the Dalton (Da) atomic mass unit. In some embodiments, the nominal mass M can be 19.018 Da less than the conventional M+H mass that includes water and a proton. Further, the peptide charge c can be in the range +1 to +4 for a peptide's spectra.

A peptide p is defined as a nonempty string over the alphabet [symbol] , where [symbol] is a set of symbols representing amino acid residues and modifications. Further, let A be a set of distinct positive numbers representing the fixed masses of the symbols in [symbol] . Thus, given an integer k, computing device 108 determines a set of at most k candidate peptide sequences, C, such that the score for the highest-scoring peptide sequence p (e.g., max_{pεC}h( [symbol] , [symbol] , A, p)) is maximized.

Computing device 108 can use the peptide scoring function h to compute a probability that the spectrum [symbol] is produced by the peptide p, based on a set of allowable amino acid modifications. In some embodiments, the scoring function, h, can compute a score for a candidate peptide sequence using additional mass spectrometry information such as proton mobility, fragmentation propensities, and mass measurement recalibration.

### Peptide Sequence Constraints

In some embodiments, peptide sequence constraints 114 can include a constraint that reduces the search space of all possible peptides down to a desired subset of the space that satisfy certain determinable criteria. The constraint can include a multiset constraint or an acyclic regular expression constraint (regex constraint). The multiset constraint can indicate a repetition count for at least one amino acid symbol of the peptide sequence. Further, an acyclic regular expression (regex) constraint can indicate at least one sequence position for an amino acid symbol of the peptide sequence.

### Multiset Constraints

A multiset constraint is a vector c: [symbol] → [symbol] , which describes a subset of all strings over the symbol space [symbol] . The set of all strings over [symbol] is denoted by [symbol] *, and the subset of [symbol] * that satisfies the constraint is denoted by S(c). A multiset constraint defines a condition for a candidate peptide sequence S(c) as follows:

if c(x)=n, then x must appear at least n times in every string in S(c).

The following vector is an example of a multiset constraint:

c(G)=1;c(V)=2;c(C)=4; and c(x)=0,∀xε [symbol] \{G,V,C}. (1)

In some embodiments, when c(x)=0, an amino acid symbol x does not impose a constraint on S(c). Thus, the subset of strings [symbol] * that satisfies constraint (1) can be described as:

S(c)={w:wε [symbol] * and w contains at least one G, at least two V, and at least four C}. (2)

For example, the sequence “VGCCQCPARCKCCV” satisfies the multiset constraint (2), but the sequence “CCPARCCVR” does not.

### Acyclic Regular Expression Constraints

In some embodiments, an n-letter acyclic regex constraint is a string cε( [symbol] ∪{ [symbol] })ⁿ describing a subset of all n-letter strings over [symbol] . For example, the string:

c= [symbol] CC [symbol] K [symbol] CC (3)

is an example of a 10-letter acyclic regex constraint. A string in S(c) must belong to [symbol] ⁿ, and must agree with every position of c that does not contain an [symbol] . Thus, the subset of strings [symbol] ⁿ that satisfies constraint (3) can be described as:

S(c)={w: wε [symbol] ⁿ and w has C in positions {2, 3, 9, 10}, and K in position 7} (4) For example, the sequence “GCCPTCKPCC” satisfies the regex constraint (3), but the sequences “CCPCKPCC” and “AGCCPTCKCC” do not.

### Deriving a Peptide Sequence

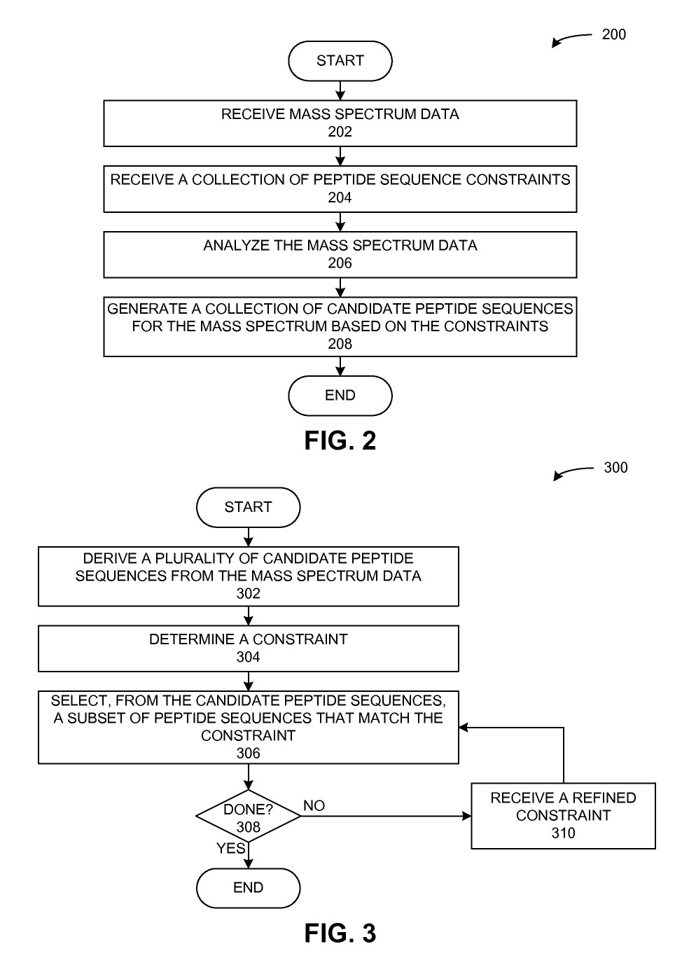

FIG. 2 presents a flow chart illustrating a process 200 for deriving a collection of candidate peptide sequences from a mass spectrum in accordance with an embodiment. During operation, the system can receive mass spectrum data collected by performing tandem mass spectrometry on a protein or a peptide (operation 202). The system can also receive a collection of peptide sequence constraints that can be used to derive a peptide sequence from the mass spectrum data (operation 204). For example, the mass spectrum data can correspond to a conotoxin, and the constraints can include a multiset constraint indicating that the desired peptide sequence includes six instances of the amino acid with symbol C.

The system can then analyze the mass spectrum data to generate intermediate data that can be used to derive a peptide sequence (operation 206), and can generate a collection of candidate peptide sequences for the mass spectrum based on the constraints and the intermediate data (operation 208). In some embodiments, the system can use the constraints when generating the intermediate data or when generating the candidate peptide sequences (e.g., during operations 206 and/or 208). For example, during operation 206, the system can analyze the mass spectrum data to generate an initial set of peptide sequences from the mass spectrum data. Then, at operation 208, the system can reduce the initial set of peptide sequences to a desired collection by selecting the peptide sequences that satisfy the constraints. As another example, during operation 206, the system can use the mass spectrum data and constraints to generate a graph structure whose paths represent candidate peptide sequences. Then, at operation 208, the system can derive a peptide sequence from the directed graph by selecting a path that satisfies the constraints and best explains the mass spectrum data.

FIG. 3 presents a flow chart illustrating a process 300 for using a constraint to select a collection of candidate peptide sequences in accordance with an embodiment. During operation, the system derives a plurality of candidate peptide sequences from the mass spectrum data (operation 302). In some embodiments, a lab technician can configure the system to generate a plurality of candidate peptide sequences using any in-house process or third-party software that the lab technician has learned to rely on for generating high-quality peptide sequences. For example, the lab technician can configure the system to select a plurality of peptide sequences that best explain the mass spectrum data from a proprietary and/or a third-party protein database. As another example, the lab technician can configure the system to use a proprietary and/or a third-party software system that has been known to generate a high-quality collection of peptide sequences from the mass spectrum data alone.

However, this initial collection of possible peptide sequences may be substantially large so as to require an undesirable amount of human effort to determine the correct peptide sequence. This manual effort is often too complicated to perform on the complete set of candidate peptide sequences, and thus it is necessary for the lab technician to reduce this set.

In some embodiments, a user (e.g., a lab technician) can generate an additional constraint that can be used to prune the existing collection of peptide sequences (operation 304), and the system can use the constraint to select the collection of peptide sequences that match the constraint (operation 306). Thus, the user can use prior knowledge about the type of protein or peptide being sequenced to make an assumption about a particular repetition count and/or placement for a certain amino acid, and can create a constraint that the system uses to select the peptide sequences. For example, alpha-conotoxins are known to contain 4 cysteines (with amino acid symbol C), thus the user may create a multiset constraint:

c(C)=4; and c(x)=0,∀xε [symbol] \{G,V,C}. (5)

The notation in multiset constraint (5) indicates that the constraint is for an amino acid represented by the symbol “C,” and that a candidate peptide sequence needs to include at least four instances of the C amino acid.

In some embodiments, the user can iteratively refine the constraint to further prune the collection of peptide sequences that are selected during operation 306. The system may determine whether the user desires to further prune the remaining collection of peptide sequences (operation 308). If so, the system can receive a refined constraint from the user (operation 310), and returns to operation 306 to select peptide sequences from the remaining collection that match the refined constraint.

The system may iterate between operations 310 and 306 to allow the user to modify or refine the constraints as necessary until the initial collection of peptide sequences has been pruned to a subset that is likely to correspond to a certain protein or peptide. For example, the user may refine the multiset constraint at operation 310 by increasing the minimum number of C amino acids to six.

As a further example, the user may desire to create a stricter constraint without increasing the minimum number of C amino acids. The user may determine that a large portion of the pruned set of peptide sequences includes the C amino acid at positions {2, 3, 8, 12, 15, 16}. Thus, the user may refine the constraint during operation 310 by generating the following regex constraint indicating these positions for the C amino acid:

C= [symbol] CC [symbol] C [symbol] G [symbol] CC. (6)

The subset of strings [symbol] ⁿ that satisfies constraint (6) can be described as:

S(c)={w:wε [symbol] ⁿ and w has C in positions 2,3,8,12,15,16}. (7)

Then, after receiving the modified constraint, the system returns to operation 306 to prune the remaining collection of peptide sequences using the modified constraint.

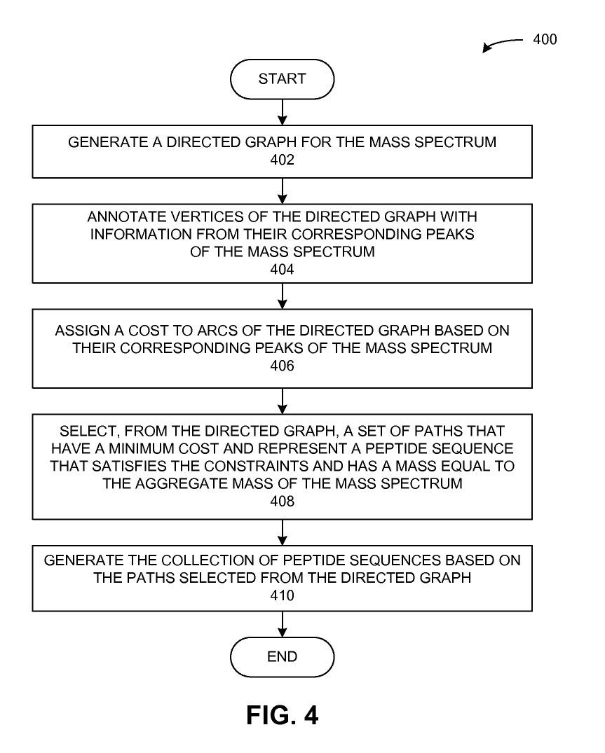

FIG. 4 presents a flow chart illustrating a process 400 for using a constraint to generate a collection of peptide sequences in accordance with an embodiment. During operation, the system can begin by generating a directed graph for the mass spectrum (operation 402). The directed graph can include a set of vertices, such that a vertex of the graph corresponds to an amino acid of a peptide sequence. The directed graph can also include a set of directed edges, such that an edge connecting two vertices of the graph indicates an ordering for the two vertices. In some embodiments, the directed graph is an acyclical graph rooted at a root node, and a path in the graph starting at the root node indicates a candidate peptide sequence. The root node, for example, can be a dummy root node that serves as a starting point for a collection of paths that represent candidate peptide sequences, such that the root node does not itself indicate an amino acid of a peptide sequence.

The system can annotate vertices of the directed graph with information pertaining to their corresponding peaks of the mass spectrum (operation 404). Further, the system can assign a cost value to edges of the directed graph based on their corresponding peaks of the mass spectrum (operation 406). For example, the system can assign a cost to an edge that couples a vertex v₁ to a vertex v₂ of the directed graph based on a presence of a supporting peak in the mass spectrum corresponding to the mass of vertex v₂. The system can also assign a cost to the edge based on an intensity of the supporting peak. Further, the system can assign a cost to the edge based on an amount by which a mass difference between peaks for the vertices v₁ and v₂ resembles an amino acid mass.

The system can then derive a collection of peptide sequences using the directed graph. For example, a user can provide constraints indicating properties of a desired peptide sequence. Then, the system can select, from the directed graph, a set of paths that have a minimum cost and each represents a valid peptide sequence (operation 408). The system then generates a collection of peptide sequences based on the paths selected from the directed graph (operation 410). Each valid peptide sequence satisfies the constraints and has a mass equal to the total mass of the peptide as determined from the mass spectrum.

In some embodiments, process 400 may be used to generate an initial collection of peptide sequences (e.g., during operation 302 of process 300). Thus, if the user desires to prune this initial collection of peptide sequences, the user can refine the constraints (e.g., during operation 310), and can use the refined constraints to prune the collection of peptide sequences (e.g., during operation 306).

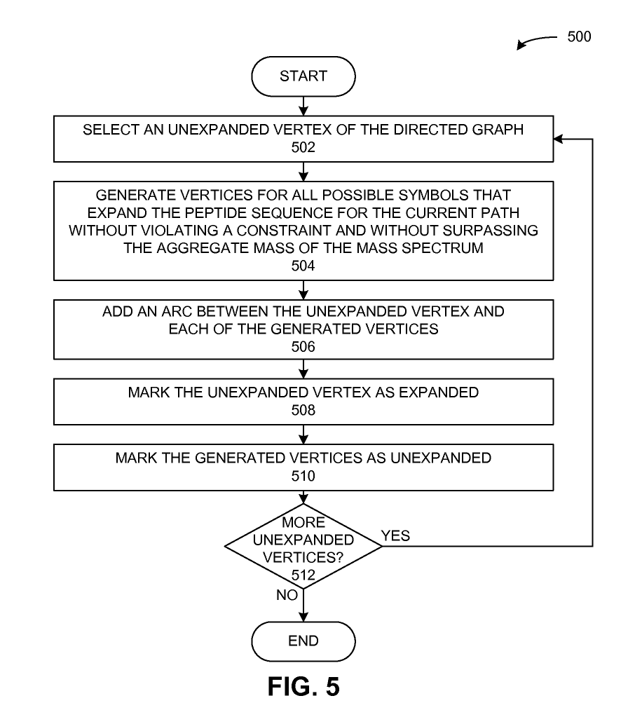

FIG. 5 presents a flow chart illustrating a process 500 for generating a directed graph for generating a peptide sequence in accordance with an embodiment. During operation, the system can select an unexpanded vertex of the directed graph (operation 502). Initially, the unexpanded vertex corresponds to the dummy root node of the directed graph. Once a vertex has been added to the directed graph, the unexpanded vertex may correspond to a leaf node of the directed graph whose path from the root node corresponds to a valid partial peptide sequence (a peptide sequence prefix). In some embodiments, a valid peptide sequence prefix includes a peptide sequence that does not violate any constraints and has a mass that does not surpass the total mass of the peptide as determined from the mass spectrum.

The system then generates vertices for all possible symbols that expand the peptide sequence prefix for the current path without violating a constraint and without surpassing the total mass of the peptide as determined from the mass spectrum (operation 504). Next, the system adds an edge between the unexpanded vertex and each of the generated vertices (operation 506). Then, the system marks the unexpanded vertex as expanded (operation 508), and marks each of the generated vertices as unexpanded (operation 510). The system then determines whether more unexpanded vertices remain (operation 512). If so, the system returns to operation 502 to select an unexpanded vertex of the directed graph. Otherwise, if no more unexpanded vertices remain, the system has explored all possible candidate peptide sequences for the mass spectrum and the constraints.

```
TABLE 1
Require:  Amino acid symbols [symbol]
          Constraint c: [symbol]   → [symbol]   , [symbol]   _{c}, A_{c};
          Spectrum [symbol]   = (T, M);
          Number of candidates K
V(G)←(0, (0,...,0))
E(G)←{ }
while more vertices in V(G) remain to be expanded do
    (m, (v1,..., vₙ)) ← next unexpanded vertex from V(G)
    for every a∈ [symbol]   do
      if m + mass(aᵢ) ≦ M then
          if a∈A_{c} then
            Let a be the i^{th} symbol in [symbol]   _{c}, denoted by aᵢ
            If (m+mass(aᵢ),(v₁,...,vᵢ+1,...,vₙ)) ∉ V(G) then
                (m′,v′)←(m+mass(aᵢ),(v₁,...,vᵢ+1,...,vₙ))
                V(G) ← V(G) ∪ {(m′, v′)}
                Mark (m′, v′) as unexpanded
            end if
          else
            if (m + mass(aᵢ), (v₁,..., vₙ)) ∉ V(G) then
                (m′, v′) ← (m + mass(aᵢ), (v₁,..., vₙ))
                V(G) ← V(G) ∪ {(m′, v′)}
                Mark (m′, v′) as unexpanded
            end if
          end if
          E(G) ← E(G) ∪ new arc from (m, v) to (m′, v′)
      end if
    end for
end while
Annotate each vertex in V(G) with peaks in T supporting its mass
Assign weights to each arc in E(G)
Obtain K shortest paths between (0,(0,...,0)) and (M,(c(a₁),...,c(aₙ)))
if no such path exists then
    Stop and report an unsatisfiable constraint error
else
    Translate each path of vertices into a string over [symbol]
    Return this set of peptides
End if
```

Table 1 presents an exemplary pseudo-code for a process that performs multiset-constrained de novo sequencing in accordance with an embodiment. The process can take as input a set of amino acid symbols [symbol] (including modifications), and a mass spectrum [symbol] =(T, M). The process can also take as input a positive integer, K, that indicates a desired number of candidate peptide sequences, and a multiset constraint c. In some embodiments, the mass spectrum can be deisotoped and decharged.

The pseudo-code listed in Table 1 provides a two-stage process that generates a set of K peptides derived from the spectrum [symbol] , each satisfying the multiset constraint c. The first stage constructs a directed multigraph G, in which each vertex in G is a tuple that includes an integer mass in the interval [0, M] and a count of the number of each of the symbols in c consumed by a prefix ending at the vertex. The process creates an arc between two vertices whose mass differs by that of an amino acid mass and which have compatible symbol counts. In some embodiments, the process assigns, to an arc of G, a cost determined based on the best peaks in T that support the terminal vertices for the arc.

The second stage of the multiset-constrained process determines the K shortest paths in G corresponding to peptide sequences that satisfy the multiset constraint c. Each path starts at the root vertex (e.g., representing mass zero with no symbols consumed from the multiset constraint), and the path ends at a vertex representing the mass M in which all the symbols appearing in the multiset constraint are consumed.

In Table 1, V(G) and E(G) denote the set of vertices and arcs (directed edges) in the directed multigraph G, respectively, and A denotes the set of masses of the amino acids represented by the symbols in [symbol] . Further, [symbol] _{c} denotes the set of amino acid symbols {a₁, . . . , aₙ} in the constraint c (e.g., c(aᵢ)>0), and A_{c} denotes the corresponding masses of the amino acids represented in [symbol] _{c}. Then,

V(G)={(m,v):mεspan(A) and m≦M;vεΠᵢ₌₁^{n{}0 . . . , c(aᵢ)}}.

Here, the product is the usual Cartesian product of sets, and span(A) denotes the union of the set of numbers that can be written as a sum of elements of A and the set {0}. Thus, a vertex (m, v) represents the mass of a prefix with weight m, and represents n bounded counters denoted by v₁, . . . , vₙ. The i^{th} counter keeps a count of the number of a symbols consumed by the prefix (e.g., a path ending at that vertex) of any peptide sequence constructed using the vertex.

In some embodiments, the vertices x=(m₁, u) and y=(m₂, v) in V(G) are related by an arc from x to y if and only if either of the following conditions is satisfied:

m₂−m₁εA\A_{c} and u=v i.

m₂−m₁ is the mass of aᵢε [symbol] _{c}, and vₖ={ᵤ_{ₖ}_{,k≠i}^{u}^{ₖ}^{-1,k=i} ii.

Condition (i) indicates that an arc is to be created between vertices x and y if their mass difference is an element of the set A but is not an element of the set A, (e.g., the mass corresponds to an amino acid not in the multiset constraint c). Condition (ii) indicates that an arc is to be created between vertices x and y if their mass difference matches that of a constrained amino acid aᵢ, and the symbol count at vertex y is greater than that at vertex x by one only for the constrained amino acid a (e.g., for the amino acid symbol at counter position i).

Further, the process annotates a vertex of the multigraph G with information about supporting peaks, if any, from the given spectrum. For example, consider the directed multigraph constructed under a constraint c(C)=4, and consider a vertex (320, (2)). This vertex represents a mass of 320 Da, and represents a prefix containing two C symbols out of the minimum of four required by the constraint, assuming carbamidomethylated cysteine. The process then searches the peak list in the mass spectrum for b-ions (e.g., peaks in the interval 321.00728±ε Da) and y-ions (e.g., peaks in the interval M−300.98±ε) to support this vertex, for a given fragment mass error tolerance of E.

Then, the process assigns costs to each arc in G based on this annotated information about the presence of supporting peaks, their intensity, and the resemblance of the mass difference of peaks across an arc to an amino acid mass. Vertices with no support contribute to a penalty for all their arcs. The system then obtains K least-cost paths between the root vertex and a leaf vertex of mass M, and such that the leaf vertex includes prefix symbol counts that match or exceed the corresponding symbol counts in the multiset constraint.

In some embodiments, when [symbol] _{c} is empty, the process guarantees that every candidate peptide sequence is considered. The condition in line 5 “if m+mass (aᵢ)≦N” ensures that the process considers only peptide sequences with a mass that does exceed the mass reported by the spectrum. Further, because the process obtains K shortest paths between the root node (0, (0, . . . , 0)) and the leaf node (M, (c(a₁), . . . , c(aₙ))), the process selects the candidate peptide sequences that have a mass M.

When [symbol] _{c} is not empty, the set [symbol] _{c} can contain one or more constrained symbols that are to be present in a candidate peptide sequence. The process selects only paths ending in a vertex with symbol counts matching the multiset constraint and having a mass matching the mass M reported in the spectrum. In some embodiments, the process does not generate unreachable vertices, for example, a vertex having a mass that exceeds the peptide mass indicated by the mass spectrum, or a vertex having symbol counts that exceed those indicated by a multiset constraint.

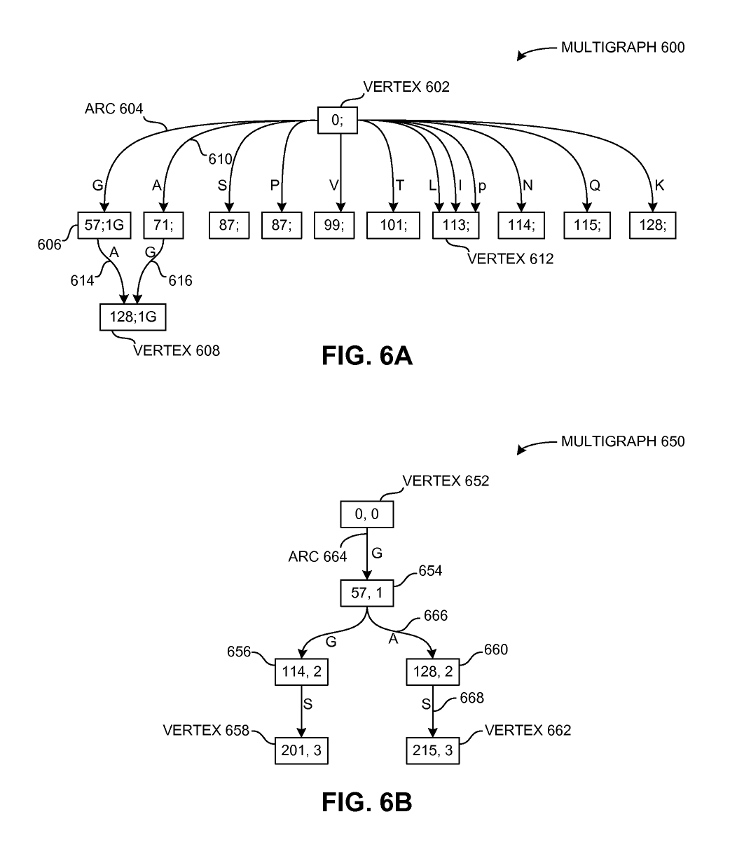

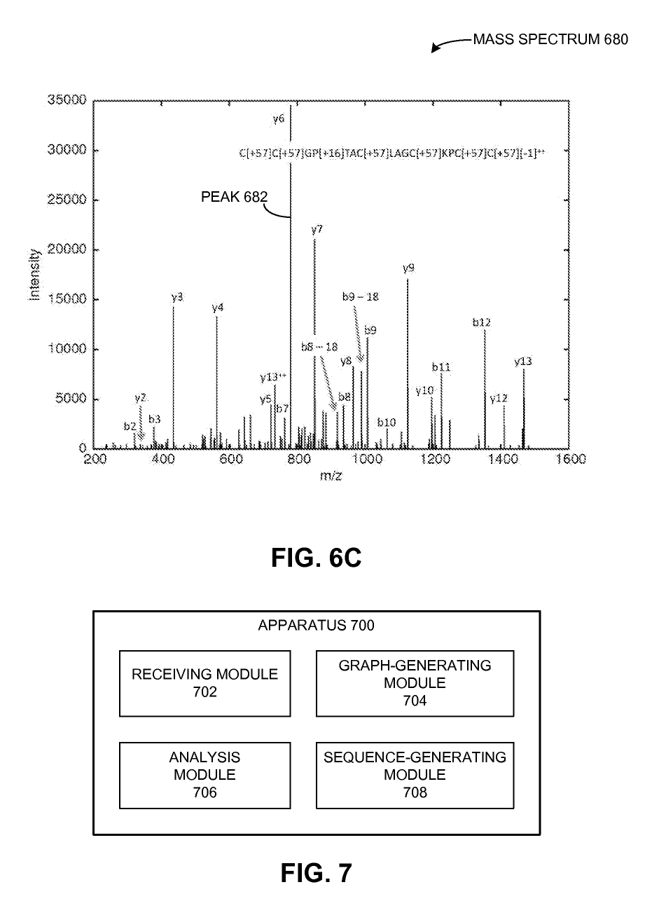

FIG. 6A illustrates an exemplary directed multigraph 600 generated using a multiset constraint in accordance with an embodiment. Vertices of directed multigraph 600 indicate an integer mass of a peptide sequence prefix that it represents (illustrated before the semicolon in a vector), and indicates a repetition count of the constrained symbols for the peptide sequence prefix (illustrated after the semicolon in a vector). Further, an arc between two vertices indicates a direction, and indicates an amino acid symbol that can explain the mass difference between the two vertices.

In some embodiments, the system generates directed multigraph 600 based on the multiset constraint “c(G)=1,” and a spectrum of 128.06 Da. Directed multigraph 600 includes a root vector 602 that indicates a zero mass (e.g., represented by the zero before the semicolon), and indicates a zero repetition count for all amino acid symbols (e.g., represented by an absence of a string after the semicolon). Also, arc 604 indicates that the amino acid with symbol “G,” which has a mass of 57 Da, best explains the mass difference between vertices 606 and 602. Further, vector 608 is coupled to vector 606 by an arc 614 associated with the amino acid with symbol “A,” which has a mass of 71 Da. Thus, vector 608 corresponds to a candidate peptide sequence that satisfies the constraint c(G)=1 and that has a mass that matches that of the mass spectrum (128 Da). Specifically, a path through arcs 604 and 614 indicates the candidate peptide sequence “GA.” Similarly, a path through arcs 610 and 616 indicates the candidate peptide sequence “AG.”

In some embodiments, two vertices of the multigraph can be coupled by multiple parallel arcs. For example, the amino acids with symbols “L,” “I,” and “p” each have a mass of 113 Da. Thus, the system can create a vertex 612 corresponding to the mass 113 Da, and can create three parallel arcs corresponding to these three amino acids with symbols “L,” “I,” and “p,” which each couple the root vertex 602 and vertex 612.

TABLE 2

```
Require:  Amino acid symbols [symbol]
          Constraint c: {1,...,n};
          Spectrum [symbol]   = (T, M);
          Number of candidates K
V(G)←(0,0)
E(G)←{ }
while more vertices in V(G) remain to be expanded do
    (m, i) ← next unexpanded vertex from V(G)
    if i=n then
      break
    end if
    if c(i+1)=“ [symbol]   ” then
      B ← [symbol]
    else
      B ← {c(i+1)}
    end if
    for every a ∈ [symbol]   do
      if m+mass(a) ≦ M then
          if (m+mass(a), i+1) ∉ V(G) then
            (m′, i′) ← (m+mass(a), i+1)
            V(G) ← V(G) ∪ {(m′, i′)}
            Mark (m′, i′) as unexpanded
          end if
          E(G) ← E(G) ∪ new arc from (m, i) to (m′, i′)
      end if
    end for
end while
Annotate each vertex in V(G) with peaks in T supporting its mass
Assign weights to each arc in E(G)
Obtain K shortest paths between (0,0) and (M,n)
if no such path exists then
    Stop and report an unsatisfiable constraint error
else
    Translate each path of vertices into a string over [symbol]
    Stop and return this set of peptides
End if
```

Table 2 presents an exemplary pseudo-code for performing regex-constrained de novo sequencing in accordance with an embodiment. The process can take as input a set, [symbol] , of amino acid symbols (including modifications), and a mass spectrum [symbol] =(T, M). The process can also take as input a positive integer, K, that indicates a desired number of candidate peptide sequences, and a regex constraint c. In some embodiments, the mass spectrum can be deisotoped and decharged.

The pseudo-code listed in Table 2, similar to that of Table 1, provides a two-stage process that generates a set of K peptides derived from the spectrum [symbol] , each satisfying the regex constraint c. The main difference is in the information represented in each vertex of graph G, and the information represented in the regex constraint c. In some embodiments, the regex constraint c can be an n-letter string that indicates a symbol pattern that the candidate peptide sequences are to match. For example, if the regex constraint indicates a non-wildcard symbol for a position i, then a candidate peptide sequence is to include this symbol at position i.

The first stage of the regex-constrained process constructs a directed multigraph G, in which each vertex in G is a tuple that includes an integer mass in the interval [0, M] and a count of the number of symbols in the prefix ending at the vertex. Thus,

V(G)={(m,v): mεspan(A) and m≦M;vε{0, . . . ,n}}.

In some embodiments, two vertices x=(m₁, v) and y=(m₂, v+1) in V(G) are related by an arc in E(G) from x toy if and only if m₂−m₁εA.

Thus, the process creates an arc between two vertices whose mass differs by that of an amino acid and which have compatible symbol counts. In some embodiments, the process annotates a vertex of the multigraph G with information about supporting peaks, if any, from the given spectrum. Further, the process can assign, to an arc in E(G), a cost determined based on the supporting peaks in T that support the terminal vertices for the arc.

The second stage of the multiset-constrained process determines the K shortest paths in G corresponding to peptide sequences that satisfy the regex constraint c. Each path starts at the root vertex (e.g., representing mass zero and a zero symbol count), and the path ends at a vertex representing the mass M in which all the symbols appearing in the regex constraint are consumed.

FIG. 6B illustrates an exemplary directed multigraph 650 generated using a regex constraint in accordance with an embodiment. A vertex of directed multigraph 650 indicates an integer mass of a peptide sequence prefix that it represents (illustrated before the semicolon in a vector), and indicates a number of symbols in its corresponding peptide sequence prefix (illustrated after the semicolon in a vector). Further, an arc between two vertices indicates a direction, and indicates an amino acid symbol that can explain the mass difference between the two vertices.

In some embodiments, the system generates directed multigraph 650 based on the regex constraint “G [symbol] S,” and a spectrum of 215.09 Da, where “ [symbol] ” indicates a wildcard symbol corresponding to the set of possible amino acid symbols. Directed graph 650 includes a root vector 652 that indicates a zero mass (e.g., represented by the zero before the semicolon), and indicates a zero sequence count (e.g., represented by the zero after the semicolon). Also, arc 664 indicates that the amino acid with symbol “G,” which has a mass of 57 Da, best explains the mass difference between vertices 654 and 652. Thus, vector 654 corresponds to a peptide sequence prefix that satisfies the constrained symbol “G” for position sequence 1.

Further, a vector 662 is coupled to a vector 660 by an arc associated with the amino acid with symbol “S,” that has a mass of 87 Da. Thus, vector 662 corresponds to a candidate peptide sequence that satisfies the regex constraint “G [symbol] S,” and that has a mass that matches that of the mass spectrum (215 Da). Specifically, a path formed by arcs 664, 666, and 668 indicates the candidate peptide sequence “GAS.”

The multigraph 650 can also include vectors 656 and 658 whose mass difference corresponds to the constrained symbol “S” at position 3. Thus, vector 658 corresponds to a peptide sequence “GGS” that satisfies the regex constraint “G [symbol] S.” However, because the mass indicated by vector 658 does not match the mass for the mass spectrum, any path that ends at vector 658 does not indicate a valid candidate peptide sequence.

FIG. 6C illustrates an exemplary mass spectrum 680 for a C. textile toxin in accordance with an embodiment. Specifically, mass spectrum 680 includes a peak 682 corresponding to a mass-to-charge ratio of approximately 785 Da/e, and an intensity of approximately 35000. In some embodiments, peak 682 indicates the expected total mass for the peptide being sequenced (CCGPTACLAGCKPCC).

The mass errors for mass spectrum 680 are less than 4 ppm. However, this mass spectrum has two posttranslational modifications (PTMs): hydroxyproline and amidated C-terminus. Also, mass spectrum 680 has missing cleavages at b1/y14 and b4/y11 (after hydroxyproline). Therefore, despite the high-accuracy, mass spectrum 680 is typically challenging to sequence without using constraints to provide prior knowledge because the closest known conotoxin is two substitutions away (CCGPTACMAGCRPCC).

FIG. 7 illustrates an exemplary apparatus 700 that facilitates deriving a peptide sequence from a mass spectrum in accordance with an embodiment. Apparatus 700 can comprise a plurality of modules which may communicate with one another via a wired or wireless communication channel. Apparatus 700 may be realized using one or more integrated circuits, and may include fewer or more modules than those shown in FIG. 7. Further, apparatus 700 may be integrated in a computer system, or realized as a separate device which is capable of communicating with other computer systems and/or devices. Specifically, apparatus 700 can comprise a receiving module 702, a graph-generating module 704, an analysis module 706, and a sequence-generating module 708.

In some embodiments, receiving module 702 can receive a description for a peptide sequence constraint and a mass spectrum. The constraint can indicate a symbol pattern that is to be present in a peptide sequence derived from the mass spectrum. Graph-generating module 704 can generate a directed graph originating at a root vertex, wherein the directed graph includes at least one graph vertex having a mass corresponding to a prefix for a candidate peptide sequence.

Analysis module 706 can select, from the directed graph, a set of paths originating from the root vertex that end at a leaf vertex corresponding to a valid peptide sequence, such that a valid peptide sequence matches the constraint and has a mass that matches the total mass of the peptide as determined from the mass spectrum. Sequence-generating module 708 can derive a peptide sequence from the mass spectrum. For example, sequence-generating module 708 can generate a peptide sequence based on a path that analysis module 706 selects from the directed graph.

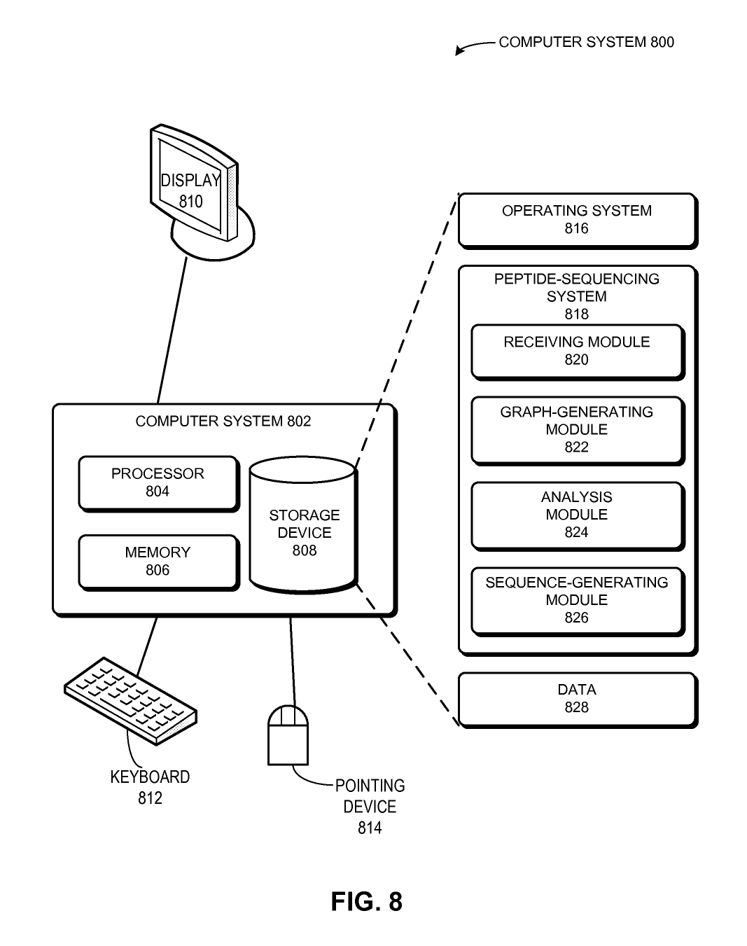

FIG. 8 illustrates an exemplary computer system 800 that facilitates deriving a peptide sequence from a mass spectrum in accordance with an embodiment. Computer system 802 includes a processor 804, a memory 806, and a storage device 808. Memory 806 can include a volatile memory (e.g., RAM) that serves as a managed memory, and can be used to store one or more memory pools. Furthermore, computer system 802 can be coupled to a display device 810, a keyboard 812, and a pointing device 814. Storage device 808 can store operating system 816, peptide-sequencing system 818, and data 828.

Peptide-sequencing system 818 can include instructions, which when executed by computer system 802, can cause computer system 802 to perform methods and/or processes described in this disclosure. Specifically, peptide-sequencing system 818 may include instructions for receiving a description for a peptide sequence constraint and a mass spectrum (receiving module 820). The constraint can indicate a symbol pattern that is to be present in a peptide sequence derived from the mass spectrum.

Peptide-sequencing system 818 can also include instructions for generating a directed graph originating at a root vertex, wherein the directed graph includes at least one graph vertex having a mass corresponding to a prefix for a candidate peptide sequence (graph-generating module 822). Further, peptide-sequencing system 818 may include instructions for selecting, from the directed graph, a set of paths originating from the root vertex that end at a leaf vertex corresponding to a valid peptide sequence (analysis module 824). A valid peptide sequence matches the constraint and has a mass that matches the total mass of the peptide as determined from the mass spectrum. Peptide-sequencing system 818 may also include instructions for deriving a peptide sequence from the mass spectrum. For example, sequence-generating module 708 can generate a peptide sequence based on a path that analysis module 706 selects from the directed graph (sequence-generating module 826).

Data 828 can include any data that is required as input or that is generated as output by the methods and/or processes described in this disclosure. Specifically, data 828 can store at least a mass spectrum, peptide sequence constraints (e.g., a multiset constraint or a regex constraint), a directed graph, and/or candidate peptide sequences.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A computer-implemented method comprising:
receiving a description for a peptide sequence constraint, wherein the constraint indicates a symbol pattern that is to be present in a peptide sequence derived from a mass spectrum; and
generating, by a computing device, a peptide sequence based on the mass spectrum and the constraint, wherein the peptide sequence matches the constraint and has a mass that matches the total mass of the peptide as determined from the mass spectrum.

2. The method of claim 1, wherein the constraint comprises a multiset constraint indicating a repetition count for at least one symbol of the peptide sequence.

3.-4. (canceled)

5. The method of claim 1, wherein generating the peptide sequence comprises:
generating a directed graph originating at a root vertex, wherein a graph vertex indicates a mass that does not exceed the total mass, and wherein the graph vertex corresponds to a peptide sequence prefix that does not violate the constraint;
selecting, from the directed graph, a set of paths originating from the root vertex that end at a leaf vertex corresponding to a valid peptide sequence, wherein a valid peptide sequence matches the constraint and has a mass that matches the total mass; and
generating a peptide sequence based on a path selected from the directed graph.

6. The method of claim 5, wherein generating the directed graph comprises annotating a vertex of the directed graph with information pertaining to a peak in the mass spectrum that corresponds to the vertex.

7. The method of claim 5, wherein generating the directed graph comprises:
assigning a cost to an edge that couples a first vertex to a second vertex of the directed graph, wherein the cost is determined based on one or more of:
a presence of a supporting peak in the mass spectrum, wherein the peak corresponds to the mass of the second vertex;
an intensity of the supporting peak; and
an amount by which a mass difference between peaks for the first and second vertices resembles an amino acid mass.

8. The method of claim 5, wherein selecting the set of paths from the directed graph comprises:
determining a number, k, of candidate peptide sequences that are to be generated;
selecting at most k paths that have a minimum cost, wherein a path's cost is equal to the aggregate cost for the path's edges; and
sorting the selected paths based on their cost.

9. A non-transitory computer-readable storage medium storing instructions that when executed by a computer cause the computer to perform a method comprising:
receiving a description for a peptide sequence constraint, wherein the constraint indicates a symbol pattern that is to be present in a peptide sequence derived from a mass spectrum; and
generating a peptide sequence based on the mass spectrum and the constraint, wherein the peptide sequence matches the constraint and has a mass that matches the total mass of the peptide as determined from the mass spectrum.

10. The computer-readable storage medium of claim 9, wherein the constraint comprises a multiset constraint indicating a repetition count for at least one symbol of the peptide sequence.

11.-12. (canceled)

13. The computer-readable storage medium of claim 9, wherein generating the peptide sequence comprises:
generating a directed graph originating at a root vertex, wherein a graph vertex indicates a mass that does not exceed the total mass, and wherein the graph vertex corresponds to a peptide sequence prefix that does not violate the constraint;
selecting, from the directed graph, a set of paths originating from the root vertex that end at a leaf vertex corresponding to a valid peptide sequence, wherein a valid peptide sequence matches the constraint and has a mass that matches the total mass; and
generating a peptide sequence based on a path selected from the directed graph.

14. The computer-readable storage medium of claim 13, wherein generating the directed graph comprises annotating a vertex of the directed graph with information pertaining to a peak in the mass spectrum that corresponds to the vertex.

15. The computer-readable storage medium of claim 13, wherein generating the directed graph comprises:
assigning a cost to an edge that couples a first vertex to a second vertex of the directed graph, wherein the cost is determined based on one or more of:
a presence of a supporting peak in the mass spectrum, wherein the peak corresponds to the mass of the second vertex;
an intensity of the supporting peak; and
an amount by which a mass difference between peaks for the first and second vertices resembles an amino acid mass.

16. The computer-readable storage medium of claim 13, wherein selecting the set of paths from the directed graph comprises:
determining a number, k, of candidate peptide sequences that are to be generated;
selecting at most k paths that have a minimum cost, wherein a path's cost is equal to the aggregate cost for the path's edges; and
sorting the selected paths based on their cost.

17. An apparatus comprising:
a receiving module to receive a description for a peptide sequence constraint and a mass spectrum, wherein the constraint indicates a symbol pattern that is to be present in a peptide sequence derived from the mass spectrum; and
a sequence-generating module to generate a peptide sequence based on the mass spectrum and the constraint, wherein the peptide sequence matches the constraint and has a mass that matches the total mass of the peptide as determined from the mass spectrum.

18. The apparatus of claim 17, wherein the constraint comprises a multiset constraint indicating a repetition count for at least one symbol of the peptide sequence.

19.-20. (canceled)

21. The apparatus of claim 17, further comprising:
a graph-generating module to generate a directed graph originating at a root vertex, wherein a graph vertex indicates a mass that does not exceed the total mass, and wherein the graph vertex corresponds to a peptide sequence prefix that does not violate the constraint;
an analysis module to select, from the directed graph, a set of paths originating from the root vertex that end at a leaf vertex corresponding to a valid peptide sequence, wherein a valid peptide sequence matches the constraint and has a total mass that matches the total mass determined; and
wherein while generating the peptide sequence the sequence-generating module is further configured to generate a peptide sequence based on a path selected from the directed graph.

22. The apparatus of claim 21, wherein while generating the peptide sequence the sequence-generating module is further configured to annotate a vertex of the directed graph with information pertaining to a peak in the mass spectrum that corresponds to the vertex.

23. The apparatus of claim 21, wherein while generating the directed graph the graph-generating module is further configured to:
assign a cost to an edge that couples a first vertex to a second vertex of the directed graph, wherein the cost is determined based on one or more of:
a presence of a supporting peak in the mass spectrum, wherein the peak corresponds to the mass of the second vertex;
an intensity of the supporting peak; and
an amount by which a mass difference between peaks for the first and second vertices resembles an amino acid mass.

24. The apparatus of claim 21, wherein while selecting the set of paths the analysis module is further configured to:
determine a number, k, of candidate peptide sequences that are to be generated;
select at most k paths that have a minimum cost, wherein a path's cost is equal to the aggregate cost for the path's edges; and
sort the selected paths based on their cost.
